(19) United States
(12) Patent Application Publication
(10) Pub. No.: US 2008/0142558 A1
(43) Pub. Date: Jun. 19, 2008

(54) Soft-sided collapsible vehicle storage organizer

(76) Inventor: Timothy J. Dexter, Orland, CA (US)

Correspondence Address: STETINA BRUNDA GARRED & BRUCKER, 75 ENTERPRISE, SUITE 250, ALISO VIEJO, CA, 92656, US

(21) Appl. No.: 11/639,629

(22) Filed: Dec. 15, 2006

(51) Int. Cl. B60R 7/02

(52) U.S. Cl. 224/275; 190/110; 224/539

(57) ABSTRACT

There is provided a soft-sided, collapsible, vehicle organizer operative to create a collapsible storage space. The vehicle organizer includes a base and a pair of opposing primary walls coupled to the base. The vehicle organizer further includes a pair of opposing secondary walls coupled to the base. The vehicle organizer is foldable between a stowed position and a deployed position. In the stowed position, at least two opposing walls are generally parallel to the base. In the deployed position, the pair of primary walls and the pair of secondary walls are substantially upright. The vehicle organizer also includes at least two batten pockets operative to receive a batten to enhance wall rigidity.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND

This invention relates in general to a storage device. Specifically, the invention relates to a soft-sided, collapsible organizer operative to create a collapsible storage space.

In today's day and age, vehicular transportation is an integral part of everyday life. Most people use vehicles to get to and from their place of employment as well as to and from points of recreation. In fact, some people work out of their vehicle. As such, people tend to store items in their vehicle, either permanently or temporarily. Such items may relate to work, play, or common necessities. An exemplary list of items commonly carried in a vehicle includes groceries, beach gear, recreational equipment, first aid supplies and work related equipment and supplies.

Due to the fact that so many items may be kept in a vehicle at any given time, it is desirable to have a storage container for storing and organizing such items. If the items are not properly stowed within the vehicle, slight acceleration, deceleration, turns and/or bumps may cause the items to move, shift, or possibly break. Therefore, storing the items within a storage container mitigates the chances that the items will shift or break during transport. Such a storage container may be placed within the vehicle, most likely the trunk or rear of the vehicle, and the items may be placed therein and removed therefrom as needed.

Although placing a container within a vehicle may advantageously create a storage space for the user, it also has inherent disadvantages as well. One disadvantage is that the space occupied by the storage container may be needed for alternate uses. For instance, a user's trunk may be needed for transport of larger items, such as golf clubs or other large cargo. Consequently, the storage container would need to be removed in order to make space for the larger item. This may be a very tedious process, especially if it must be done on a fairly regular basis.

In addition to the space that traditional storage containers consume, most storage containers do not offer flexibility with regard to the size of individual storage compartments. Rather, they tend to offer storage compartments having a fixed volume. Some storage containers contain only one storage bin, while others are divided into smaller storage compartments. In both cases, most storage containers are not capable of adjusting the storage size of each storage compartment.

Furthermore, traditional storage devices may not offer a top or lid to enclose the storage space. In many cases, the storage container may be comprised of an open-ended bin without a lid. However, even if the storage device does include a top or lid, such top or lid is generally not rigid. As such, additional items cannot be placed on top of the storage device. In addition, most lids do not include a hinge or pivot. A pivoting lid allows a user to open a portion of the lid to access the storage space without removing the entire lid.

As was stated above, many people work out of their vehicle. Therefore, they may be required to carry work-related materials with them in their vehicle. Such work related materials may include hanging files, folders, notebooks, etc. Many of the traditional storage devices mentioned above are not capable of accommodating hanging files. Therefore, the hanging files may simply be placed inside the storage container, which is not as effective as hanging the file so the file name or subject can be easily read from the tab on the hanging file.

It is therefore evident that there exists a need in the art for a soft-sided collapsible vehicle organizer operative to create a collapsible storage space within a vehicle.

### BRIEF SUMMARY

According to an aspect of the present invention, there is provided a soft-sided, collapsible, vehicle organizer operative to create a collapsible storage space. The vehicle organizer includes a base and a pair of opposing primary walls coupled to the base. The vehicle organizer further includes a pair of opposing secondary walls coupled to the base. The vehicle organizer is foldable between a stowed position and a deployed position. In the stowed position, at least two opposing walls are generally parallel to the base. In the deployed position, the pair of primary walls and the pair of secondary walls are substantially upright. The vehicle organizer also includes at least two batten pockets, each being operative to receive a batten to enhance wall rigidity.

The present invention may be used to provide a storage space within a user's vehicle. When space is needed, the vehicle organizer may be placed in the deployed position. If the user needs the space for larger items, the vehicle organizer may easily be folded into the stowed position to create space for the larger item. When in the stowed position, the vehicle organizer does not take up valuable space within a vehicle. As such, larger items such as golf clubs or large boxes may be placed in the space previously occupied by the deployed vehicle organizer.

The vehicle organizer may include at least one divider to partition the storage space when the organizer is in the deployed position. The dividers may include a pair of lower connection members detachably coupled with a pair of base connection members coupled to the base. In addition, the dividers may also include a pair of upper connection members detachably coupled with a pair of wall connection members coupled to opposing walls.

The vehicle organizer may also include a rigid lid operative to substantially cover the storage space within the organizer. The lid includes a second lid connector detachably coupled with a first lid connector, wherein the first lid connector is coupled to at least one wall. Although the lid may be comprised of one uniform body, it may also be comprised of a first lid portion and a second lid portion, wherein the first and second lid portions are in pivotal communication with each other.

According to another embodiment of the invention, there is provided a collapsible mobile office organizer operative to create a collapsible storage space for a plurality of hanging folders and other office supplies. The mobile office organizer includes a base and a pair of opposing primary walls. The pair of opposing primary walls are coupled to the base and include a wall connection member. The mobile office organizer also includes a pair of opposing secondary walls coupled to the base. The mobile office organizer is foldable between a stowed position and a deployed position. In the stowed position, at least two opposing walls are generally parallel to the base. In the deployed position, the pair of primary walls and the pair of secondary walls are substantially upright. In addition, each wall in at least one pair of opposing walls includes a batten pocket operative to receive a batten to enhance wall rigidity. The mobile office organizer also includes at least two office dividers operative to partition the storage space when the mobile office organizer is in the deployed position. Each office divider includes at least one recessed edge to support at least one hanging folder. The office dividers also include upper connection members detachably coupled to the wall connection members.

The base of the mobile office organizer may include a pair of base connection members. The mobile office organizer dividers may include a pair of lower connection members detachably coupled to the pair of base connection members.

The mobile office organizer may also include a rigid lid for covering the storage space. A first lid connector may be coupled to at least one wall. The rigid lid includes a second lid connector detachably coupled with the first lid connector. The rigid lid may be comprised of a first lid portion and a second lid portion, where the first and second lid portions are in pivotal communication with each other.

In another embodiment of the invention, there is provided a soft-sided, collapsible tote organizer operative to create a collapsible storage space. The tote organizer comprises at least two totes and a soft-sided bin configured to receive at least two totes. The bin comprises a base and a pair of opposing primary walls. In addition, the bin includes a pair of opposing secondary walls coupled to the base. The bin is foldable between a stowed position and a deployed position. In the stowed position, at least two opposing walls are generally parallel to the base. In the deployed position, the pair of primary walls and the pair of secondary walls are substantially upright. Furthermore, each wall in at least one pair of opposing walls includes a batten pocket operative to receive a batten to enhance wall rigidity.

The tote organizer may further include a tote lid coupled to at least one wall. The tote lid is operative to substantially cover the storage space of the storage and organization system. The tote lid includes a second lid connector detachably coupled with a first lid connector, wherein the first lid connector is coupled to at least one wall. Each tote may also include two fastening members operative to aid tote transportation.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a vehicle organizer in a deployed position with a rigid lid having a first lid portion and a second lid portion;

FIG. 2 is a perspective view of the vehicle organizer in the deployed position, wherein the vehicle organizer is rotated with respect to the position of the vehicle organizer in FIG. 1;

FIG. 3 is a perspective view of the vehicle organizer, wherein the second portion of the lid is raised to allow a user access into a storage space;

FIG. 4 is a sectional side view of the vehicle organizer wherein a batten is located within a batten pocket located on each primary wall;

FIG. 5 is a perspective view of the vehicle organizer wherein the lid is detached from the vehicle organizer;

FIG. 6 is an exploded view of the vehicle organizer;

FIG. 7 is a perspective view of the vehicle organizer in a stowed position;

FIG. 8 is a perspective view of a mobile office organizer in the deployed position, wherein the mobile office organizer includes three office dividers; and

FIG. 9 is as perspective view of a tote organizer in a deployed position, wherein the tote organizer includes a bin operative to receive four totes.

### DETAILED DESCRIPTION

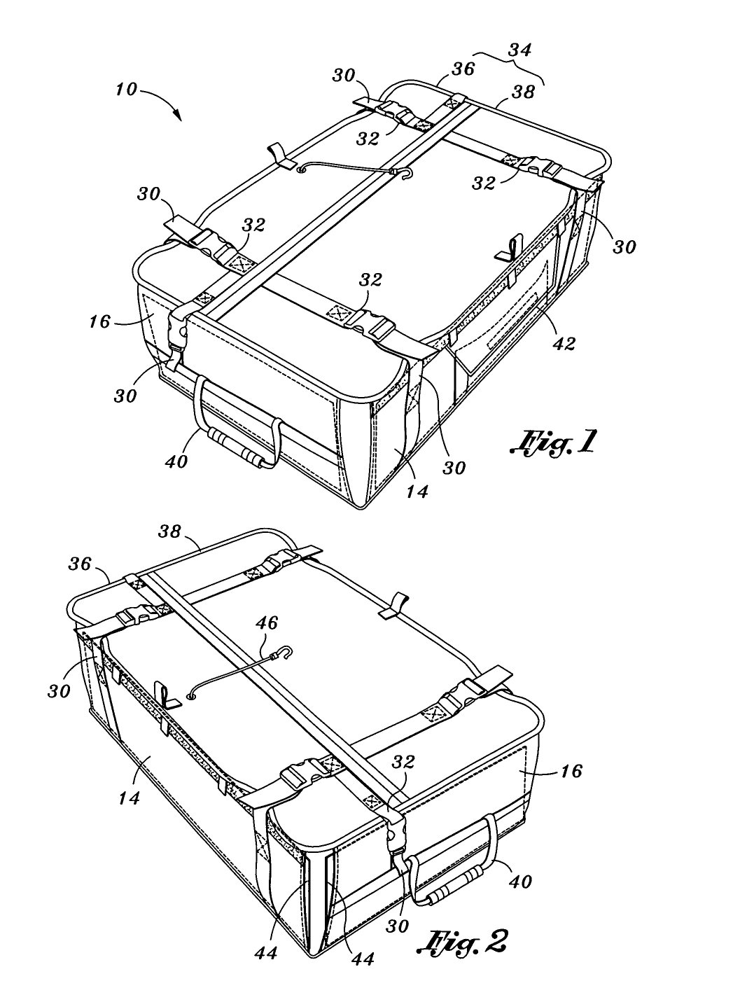

Referring now to the drawings wherein the showings are for purposes of illustrating a preferred embodiment of the present invention only, and not for purposes of limiting the same, FIG. 1-7 illustrates a soft-sided, collapsible, vehicle organizer 10 operative to create a collapsible storage space. The vehicle organizer 10 includes a base 12 and two pair of opposing walls; namely, a pair of opposing primary walls 14 and a pair of opposing secondary walls 16, wherein each of the primary walls 14 and secondary walls 16 are coupled to the base 12.

The vehicle organizer 10 is foldable between a stowed position and a deployed position. FIGS. 1-6 illustrates the vehicle organizer 10 in the deployed position, while FIG. 7 illustrates the vehicle organizer 10 in the stowed position. In the stowed position, at least two opposing walls are generally parallel to the base 12. In this regard, the opposing primary walls 14 may be generally parallel to the base 12, or the opposing secondary walls 16 may be generally parallel to the base 12. In the embodiment shown in FIG. 7, the opposing secondary walls 16 are collapsed, while the opposing primary walls 14 are generally parallel to the base 14. In the deployed position, the pair of primary walls 14 and the pair of secondary walls 16 are substantially upright. In one embodiment, the walls 14, 16 are substantially upright when they are generally perpendicular to the base 12. However, it is understood that in other embodiments the walls 14, 16 are not exactly perpendicular to the base 12. According to one embodiment, there is an obtuse angle between the base 12 and at least one of the primary walls 14 or the secondary walls 16 to allow easier access into the storage space. In this embodiment, the angled wall is considered to be substantially upright, despite the obtuse angle.

According to various embodiments, the primary and secondary walls 14, 16 of the vehicle organizer 10 are soft-sided. In this regard, the walls 14, 16 are selectively deformable to allow a user to fold the organizer 10 to conserve space. Each of the primary and/or secondary walls 14, 16 may include a batten pocket 18, wherein each batten pocket 18 is operative to receive a batten 44 to enhance wall rigidity. Battens 44 are thin planar members that are made of a substantially rigid material. Preferably, the battens 44 are made of an ABS or vinyl material, but other materials known by those skilled in the art may also be used. Battens 44 are inserted into the batten pockets 18 located in the walls 14, 16 of the vehicle organizer 10 in order to provide rigidity and strength when the vehicle organizer 10 is in the deployed position. The batten pockets 18 are configured to tightly conform to the battens 44. The battens 44 substantially increase the compaction and strength of the vehicle organizer 10. They enable the soft-sided organizer 10 to function as a hard-sided container.

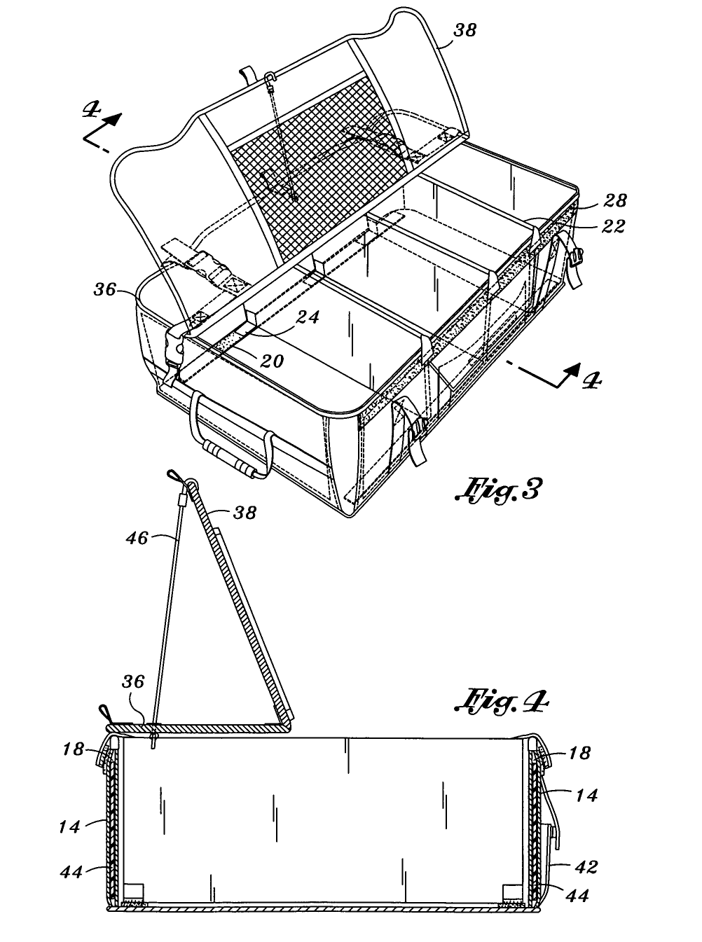

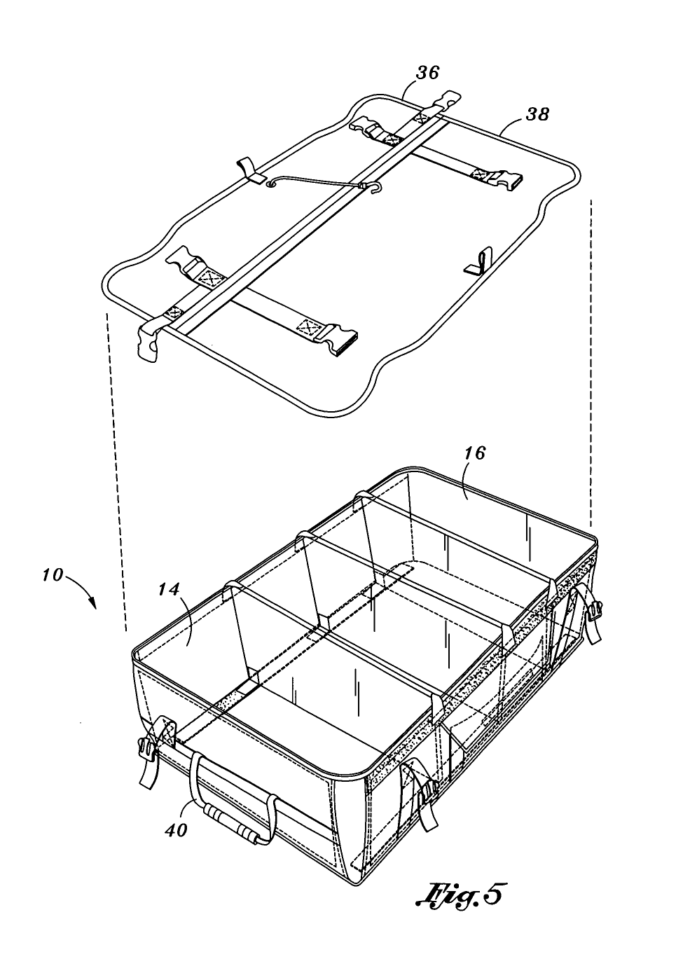

When the vehicle organizer 10 is in the deployed position, each wall 14, 16 includes a batten 44. Battens 44 are removed from the batten pocket 18 to allow the user to fold the vehicle organizer 10 into the stowed position. FIG. 4 illustrates a sectional view of a vehicle organizer 10 having battens 44 within batten pockets 18 located on the opposing primary walls 14. In order to fold the vehicle organizer 10 from the deployed position to the stowed position, two battens 44 must be removed from the vehicle organizer 10. Two battens 44 must be removed from either the primary walls 14 or the secondary walls 16. Given that only two battens 44 must be removable, only two batten pockets 18 are required. Therefore, in one embodiment, either the primary walls 14 or the secondary walls 16 include batten pockets 18. In such an embodiment, the remaining walls may have battens 44; however, they may not be removable battens 44. In the embodiment shown in FIG. 2, all four walls 14, 16 include a batten pocket 18.

It is understood that it may be advantageous to fold the vehicle organizer 10 into the stowed position when not in use. It is envisioned that the vehicle organizer 10 will be kept in the back of the user's vehicle. When additional storage space is needed, the vehicle organizer 10 may quickly be unfolded into the deployed position. When the storage space is not needed, the organizer 10 may be folded into the stowed position so that it does not take up valuable space. For instance, a user may need the space to stow a large item, such as golf clubs.

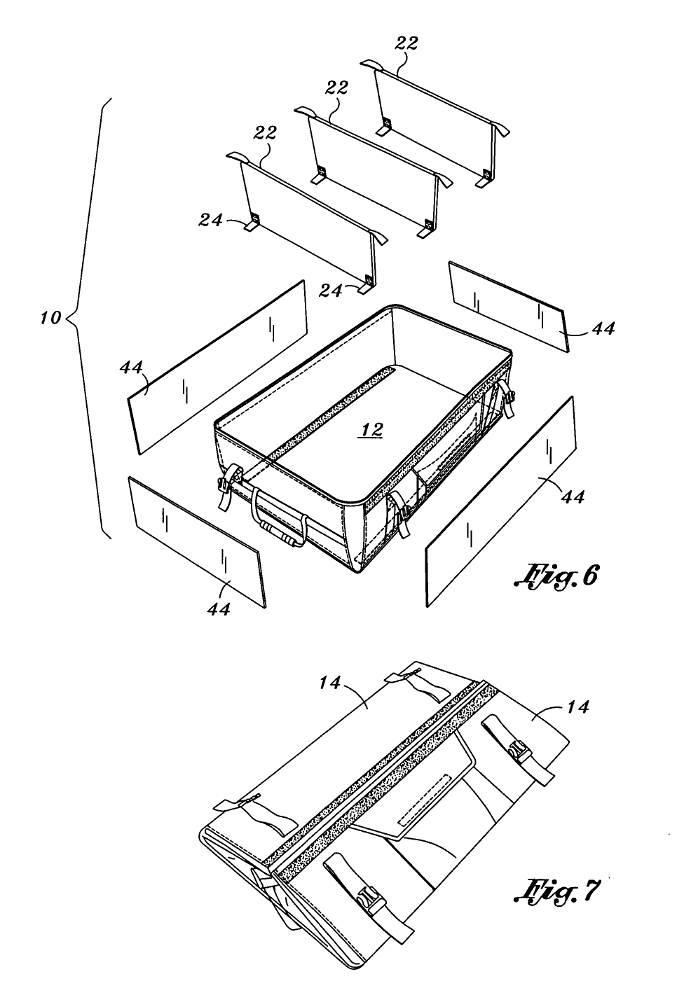

When the vehicle organizer 10 is in the deployed position, storage space is created within the organizer 10. It is contemplated that a user may want to divide the storage space created by the vehicle organizer 10. As such, one embodiment of the invention includes at least one divider 22. The divider 22 is operative to partition the vehicle organizer 10 into a number of different storage areas. The different storage areas may be used to store and organize different possessions. For example, if a family is going to a beach or park, they may place recreational equipment in one storage area, blankets/towels in another storage area, and food in still another storage area. The dividers 22 are detachably coupled to the vehicle organizer 10 and may be inserted or removed as needed. According to various embodiments, the dividers 22 may detachably couple to various parts of the vehicle organizer 10. In one embodiment, the dividers 22 detachably couple to the base 12. The base 12 includes a pair of base connection members 20, as is shown in FIGS. 3 and 5. The dividers 22 include a pair of lower connection members 24 which detachably couple with the base connection members 20. In another embodiment, the dividers 22 detachable couple to the primary walls 14 or secondary walls 16. In this embodiment, the primary walls 14 or secondary walls 16 include a pair of wall connection members 26. In the embodiment shown in FIGS. 1-7, the wall connection members 26 are coupled to the primary walls 14. However, it is understood that the wall connection members 26 may be coupled to the secondary walls 16. The dividers 22 include a pair of upper connection members 28 detachably coupled to the wall connection members 26. It is also contemplated that the vehicle organizer 10 may include both base connection members 20 and wall connection members 26, as is shown in FIGS. 3 and 6. In this regard, the dividers 22 are detachably coupled to the base 12 and the primary walls 14. It is contemplated that the base connection members 20 and lower connection members 24, as well as the wall connection members 26 and upper connection members 28 may be complementary hook and loop fasteners, although other fastening means known by those skilled in the art may also be used.

When the dividers 22 are placed within the vehicle organizer 10, the storage space is divided into a number of different storage compartments. In one embodiment of the invention, the position of each divider 22 may be altered to vary the size of the different storage compartments. In the embodiment shown in the drawings, the base and lower connection members 20, 24 and the wall and upper connection members 26, 28 are complementary hook and loop fasteners. As such, the position of each divider 22 may easily be changed by the user to accommodate the user's storage and organizational needs.

It may be desirable to cover the items placed within the storage space. As such, various embodiments of the invention include a lid. The lid is configured such that it substantially covers the belongings placed within the organizer 10. Preferably, the lid is a rigid lid 34 as shown in FIGS. 1-5. The rigid lid 34 is capable of supporting additional belongings placed thereon. In one embodiment, the rigid lid 34 includes a batten pocket 18 operative to receive a batten 44 to enhance the rigidity of the lid. In another embodiment, the rigid lid 34 includes a batten 44 that is permanently sown therein. The rigid lid 34 is detachably coupled to the vehicle organizer 10 via first and second lid connectors 30, 32. The vehicle organizer 10 includes a first lid connector 30 coupled to at least one primary wall 14 or one secondary wall 16. In the embodiment shown in FIG. 1, the vehicle organizer 10 includes six first lid connectors 30, wherein each primary wall 14 includes two first lid connectors 30, and each secondary wall 16 includes one first lid connector 30. The lid 34 includes a second lid connector 32 detachably coupled to the first lid connector 30. As such, the lid 34 may be attached to, or removed from the vehicle organizer 10 when necessary. As shown in FIG. 5, the lid 34 is completely removed from the vehicle organizer 10. In the embodiment shown in FIG. 1, the lid 34 includes six second lid connectors 32 coupled to the corresponding first lid connectors 30. Although the embodiment shown in FIG. 1 includes six first and second lid connectors 30, 32, it is understood that only one first lid connector 30 and one corresponding second lid connector 32 is required.

In one embodiment, the rigid lid 34 is comprised of a first lid portion 36 and a second lid portion 38. The first and second lid portions 36, 38 are in pivotal communication with each other. FIGS. 1-5 show a vehicle organizer 10 with a rigid lid 34 having a first and second lid portion 36, 38. Either the first lid portion 36 or second lid portion 38 may be lifted to access the storage space. In the embodiment shown in FIGS. 3-4, the second lid portion 38 has been lifted to access the storage space. The lid 34 may also include a lid tether 46, as shown in FIGS. 1 and 4. The lid tether 46 is operative to hold open either the first lid portion 36 or second lid portion 36 so the user may access the storage space.

In order to enhance the portability of the vehicle organizer 10, at least one handle 40 may be coupled to at least one of the walls 14, 16. In the embodiment shown in FIGS. 1-2, the vehicle organizer 10 includes two handles 40; one handle 40 on each secondary wall 16. It is understood that the vehicle organizer 10 may include handles 40 on each primary wall 14, or handles 40 on every wall 14, 16. The portability of the vehicle organizer 10 may further be enhanced by a pair of wheels, similar to luggage or suitcases that include wheels to enhance portability. As such, one embodiment includes a pair of wheels coupled to the base 12. The wheels allow a user to roll the vehicle organizer 10 on the ground rather than carry the organizer 10. This may be particularly beneficial when the organizer 10 contains many of the user's belongings and is particularly heavy.

The storage capacity of the vehicle organizer 10 may be enhanced with the addition of at least one storage pocket 42. In the embodiment shown in FIG. 1, there is a storage pocket 42 coupled to one of the primary walls 14, although storage pockets 42 may also be coupled to the secondary walls 16.

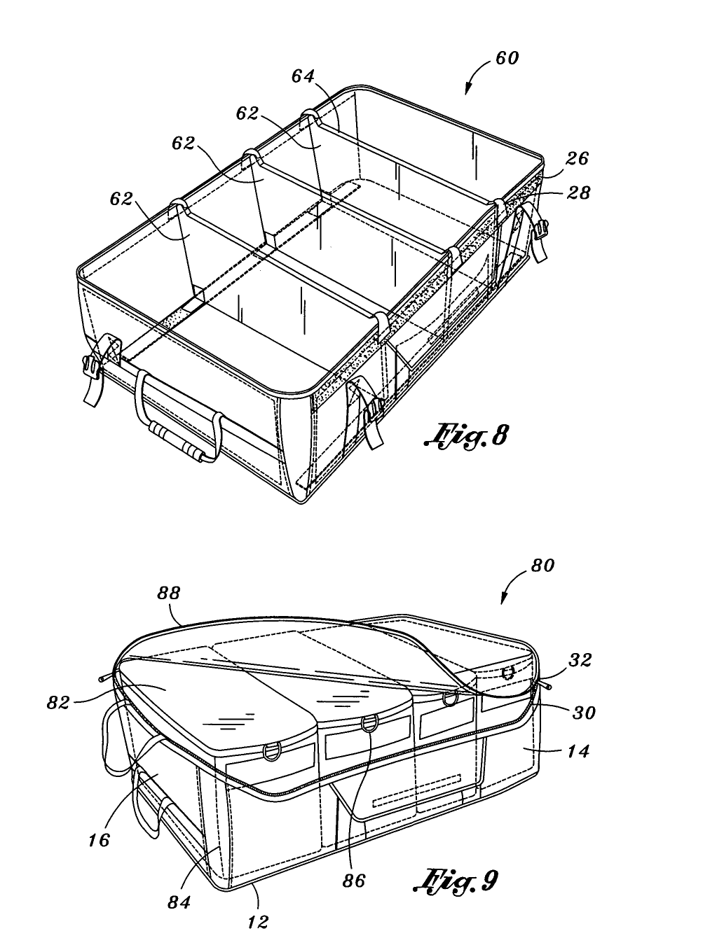

In addition to the foregoing, it is expressly contemplated that the present invention may find widespread applicability to not only use in general storage and organization applications, but may further be implemented to provide mobile office organization and storage. As such, one embodiment of the present invention is a mobile office organizer 60. The mobile office organizer 60 is similar to the vehicle organizer 10 described above, however, the mobile office organizer 60 includes office dividers 62 that are different from the dividers 22 of the vehicle organizer 10. Referring now to FIG. 8, a mobile office organizer 60 includes at least two office dividers 62 operative to partition the storage space when the office organizer 60 is in the deployed position. The office dividers 62 also operate to support hanging folders. The office dividers 62 are different from the dividers 22 described above in that the office dividers 62 include a recessed edge 64 to more effectively support a hanging folder. The hanging folders are support by two office dividers 62. Most hanging folders include a raised tab that is used to identify the contents of the folder. The recessed edge 64 allows the hanging folders to hang with the storage space, yet still allow the lid 34 to be placed on top of the mobile office organizer 60. Without the recessed edge 64, the tabs on the hanging folders may sustain damage when the lid 34 is closed. Although FIG. 8 illustrates the mobile office organizer 60 without a lid 34, it is understood that the lid 34 can be placed on the mobile office organizer 60 to cover the storage space.

In another embodiment, the present invention may be used as a soft-sided, collapsible tote organizer 80. The tote organizer 80 is comprised of at least two totes 82 and a bin 84 configured to receive at least two totes 82. The bin 84 is similar to the vehicle organizer 10 described above in that the bin 84 includes a base 12, a pair of opposing primary walls 14, and a pair of opposing secondary walls 16. The primary and secondary walls 14, 16 are coupled to the base 12. The bin 82 is foldable between a stowed position and a deployed position. In the stowed position, either the primary walls 14 or the secondary walls 16 are generally parallel to the base 12. In the deployed position, the pair of primary and secondary walls 14, 16 are substantially upright. Similar to the vehicle organizer 10, the rigidity of the tote organizer walls are enhanced by battens 44. At least one pair of opposing walls, namely the primary walls 14 or secondary walls 16 includes a batten pocket 18 operative to receive a batten 44 to enhance wall rigidity.

It is contemplated that the totes 82 may be removed from the bin 84 as the user desires. The totes 82 may be general purpose totes 82, or cooler totes 82. The general purpose totes 82 may be used for general storage and organization purposes. The cooler totes 82, on the other hand, include foam and insulation and are used to insulate its contents from the outside temperature. In one embodiment, the totes 82 include a fastening member 86 operative to aid tote transportation. A strap may be attached to the fastening member 86 to enable easy transportation of the tote 82. The user may return the tote 82 to the bin 84 and remove the strap from the fastening member 86.

According to an aspect of the present invention, the tote organizer 80 includes a tote lid 88 to substantially cover the storage space. The tote lid 88 may be a soft lid or a rigid lid. As shown in FIG. 9, the tote lid 88 is a soft lid 88. In one embodiment, the lid 88 is coupled to at least one of the primary or secondary walls 14, 16. The lid 88 includes a second lid connector 32 which couples with a first lid connector 30 to fasten the lid to the tote organizer 80. The first lid connector 30 is coupled to at least one of the primary walls 14 or secondary walls 16. In the embodiment shown in FIG. 9, the first and second lid connectors 30, 32 are complementary zipper portions, although other fasteners known in the art may be employed.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A soft-sided, collapsible, vehicle organizer operative to create a collapsible storage space, the vehicle organizer comprising:
a base;
a pair of opposing primary walls coupled to the base; and
a pair of opposing secondary walls coupled to the base, the vehicle organizer being foldable between a stowed position wherein at least two opposing walls are generally parallel to the base, and a deployed position wherein the pair of primary walls and the pair of secondary walls are substantially upright, wherein each wall in at least one pair of opposing walls includes a batten pocket operative to receive a batten to enhance wall rigidity.

2. The vehicle organizer of claim 1, wherein the base further includes a pair of base connection members coupled to the base.

3. The vehicle organizer of claim 2, further comprising at least one divider being operative to partition the vehicle organizer, wherein each divider includes a pair of lower connection members detachably coupled with the base connection members when the organizer is in the deployed position.

4. The vehicle organizer of claim 3, wherein the lower connection members and base connection members are complementary hook and loop fasteners.

5. The vehicle organizer of claim 1, further comprising a pair of wall connection members coupled to opposing walls.

6. The vehicle organizer of claim 5, further comprising at least one divider being operative to partition the vehicle organizer, wherein each divider includes a pair of upper connection members detachably coupled with the wall connection members when the organizer is in the deployed position.

7. The vehicle organizer of claim 6, wherein the upper connection members and the wall connection members are complementary hook and loop fasteners.

8. The vehicle organizer of claim 1, further comprising a first lid connector coupled to at least one wall.

9. The vehicle organizer of claim 8, further comprising a rigid lid operative to substantially cover the storage space, wherein the rigid lid includes a second lid connector detachably coupled with the first lid connector.

10. The vehicle organizer of claim 9, wherein the rigid lid is comprised of a first lid portion and a second lid portion, the first and second lid portions being in pivotal communication with each other.

11. The vehicle organizer of claim 1, further comprising at least one handle coupled to at least one of the walls.

12. The vehicle organizer of claim 11, wherein the vehicle organizer includes two handles coupled to opposing walls.

13. The vehicle organizer of claim 1, further comprising at least one storage pocket coupled to at least one wall.

14. A soft-sided, collapsible tote organizer operative to create a collapsible storage space, the tote organizer comprising:
at least two totes; and
a bin configured to receive the at least two totes, the bin comprising:
a base;
a pair of opposing primary walls coupled to the base; and
a pair of opposing secondary walls coupled to the base, the organizer being foldable between a stowed position wherein at least two opposing walls are generally parallel to the base, and a deployed position wherein the pair of primary walls and the pair of secondary walls are substantially upright, wherein each wall in at least one pair of opposing walls includes a batten pocket operative to receive a batten to enhance wall rigidity.

15. The tote organizer of claim 14, further comprising a tote lid coupled to at least one wall, the tote lid being operative to substantially cover the storage space.

16. The tote organizer of claim 15, further comprising a first lid connector coupled to at least one wall.

17. The tote organizer of claim 16, wherein the tote lid further comprises a second lid connector detachably coupled with the first lid connector.

18. The tote organizer of claim 17, wherein the first and second lid connectors are complementary zipper portions.

19. The tote organizer of claim 14, wherein each tote includes at least one fastening member operative to aid tote transportation.

20. A soft-sided, collapsible mobile office organizer operative to create a collapsible storage space for a plurality of hanging folders, the mobile office organizer comprising:
a base;
a pair of opposing primary walls coupled to the base, each primary wall including a wall connection member;
a pair of opposing secondary walls coupled to the base, the bin being foldable between a stowed position wherein at least two opposing walls are generally parallel to the base, and a deployed position wherein the pair of primary walls and the pair of secondary walls are substantially upright, wherein each wall in at least one pair of opposing walls includes a batten pocket operative to receive a batten to enhance wall rigidity; and
at least two office dividers operative to partition the storage space when the organizer is in the deployed position, each divider including upper connection members detachably coupled to the wall connection members, wherein each divider includes at least one recessed edge.

21. The mobile office organizer of claim 20, wherein the base further includes a pair of base connection members coupled to the base.

22. The mobile office organizer of claim 21, wherein each of the at least two office dividers include a pair of lower connection members detachably coupled to the base connection members when the organizer is in the deployed orientation.

23. The mobile office organizer of claim 20, further comprising a first lid connector coupled to at least one wall.

24. The mobile office organizer of claim 23, further comprising a rigid lid operative to substantially cover the storage space, wherein the rigid lid includes a second lid connector detachably coupled with the first lid connector.

25. The mobile office organizer of claim 24, wherein the rigid lid is comprised of a first lid portion and a second lid portion, the first and second lid portions being in pivotal communication with each other.
